(19) United States
(12) Patent Application Publication
(10) Pub. No.: US 2011/0285670 A1
(43) Pub. Date: Nov. 24, 2011

(54) STYLUS PEN

(75) Inventors: XIANG LI, Shenzhen City (CN); SHA-SHA HU, Shenzhen City (CN); BO-CHING LIN, Tu-Cheng (TW)

(73) Assignees: HON HAI PRECISION INDUSTRY CO., LTD., Tu-Cheng (TW); HONG FU JIN PRCISION INDUSTRY (ShenZhen) CO., LTD., Shenzhen City (CN)

(21) Appl. No.: 13/028,221

(22) Filed: Feb. 16, 2011

(30) Foreign Application Priority Data
May 21, 2010 (CN) 201010179640.5

(51) Int. Cl. G06F 3/033

(52) U.S. Cl. 345/179

(57) ABSTRACT

A stylus pen includes a penholder and a pen tip connected to the penholder. The pen tip includes a first pen tip and a second pen tip. A first contact surface and a second contact surface are respectively defined in one end of the first pen tip and the second pen tip, and both are substantially parallel to each other. A cavity is defined in the second pen tip, in which the first pen tip is slidably received. An elastic member is arranged in the cavity to provide an elastic force to the first pen tip to cause the first pen tip to extend out of the cavity. When the pen tip is pressed, the elastic member is compressed to allow the first pen tip to retract into the cavity, allowing the first contact surface and the second contact surface to be flush with each other.

### BACKGROUND

1. Technical Field

The present disclosure relates to stylus pens and, particularly, to a stylus pen used in an electronic device with a capacitive touch screen.

2. Description of Related Art

The capacitive touch screen has been widely used as an input device in various kinds of electronic devices. A stylus pen can be used to interact with the capacitive touch screen. If the contact area between a pen tip and the capacitive touch screen is large enough, the charge variation caused by the pen tip on the capacitive touch screen can be captured, and the capacitive touch screen can determine the position of the pen tip according to the charge variation. However, if the contact area is insufficient, the charge variation cannot be captured, and the capacitive touch screen cannot determine the position of the pen tip. The user cannot complete the handwritten input on the capacitive touch screen. However, a large pen tip may also affect the exact selection of a menu item and could cause the wrong operation to take effect.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a stylus pen according to an embodiment, showing a first pen tip and a second pen tip.

FIG. 2 is a partial, cross-sectional view of the stylus pen of FIG. 1.

FIG. 3 is another schematic view of the stylus pen of FIG. 1, showing the first pen tip being completely received in the second pen tip.

### DETAILED DESCRIPTION

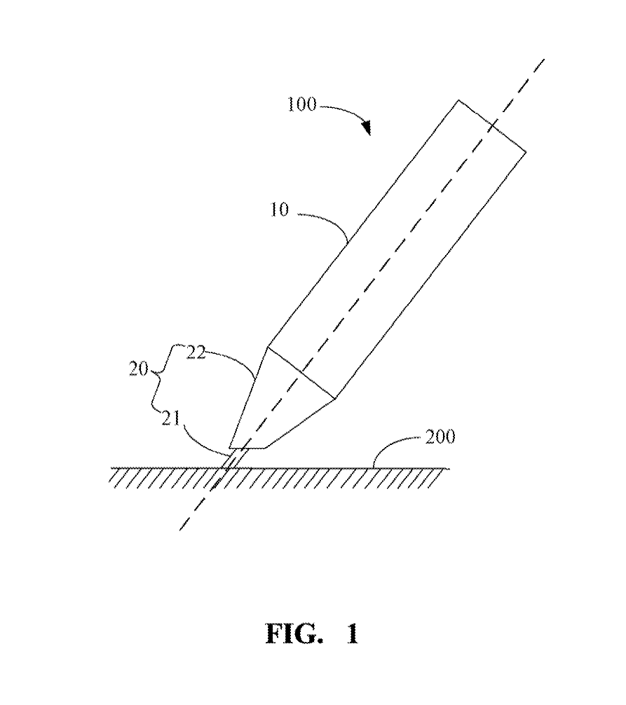

Referring to FIG. 1, a stylus pen 100 is disclosed, according to an embodiment. The stylus pen 100 includes a penholder 10 and a pen tip 20. The pen tip 20 and the penholder 10 function as a carrier that transfers inductive current from a human body to the capacitive touch screen 200. The penholder 10 may be made of rigid conductive material, entirely or in part. The pen tip 20 may be made of flexible conductive material, such that the pen tip 20 will not scratch the capacitive touch screen 200 when it is moving on the touch screen 200.

The pen tip 20 includes a first pen tip 21 and a second pen tip 22. In the embodiment, the first pen tip 21 can be retracted into the second pen tip 22. The second pen tip 22 can be detachably connected to the penholder 10 for ease of replacement and/or repair. In other embodiments, the second pen tip 22 may be securely fixed to the penholder 10.

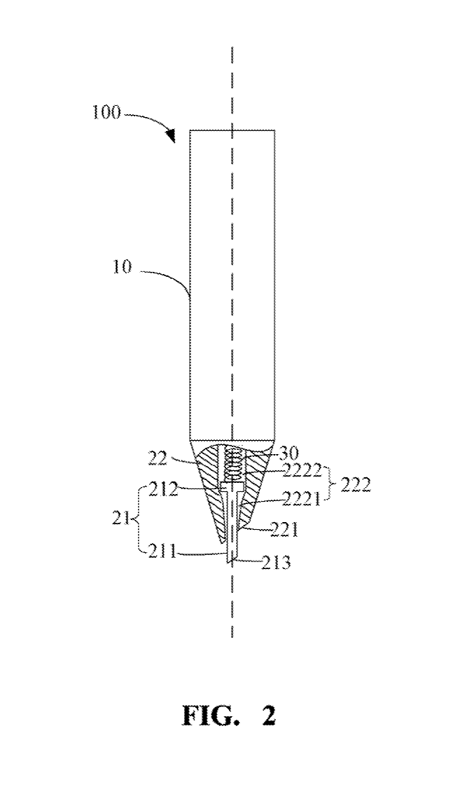

Referring to FIG. 2, the first pen tip 21 includes a rod 211 and a head 212 formed at one end of the rod 211. In the embodiment, the other opposite end of the rod 211 includes a first contact surface 213, and the end of the second pen tip 22 away from the penholder 10 includes a second contact surface 221. In the embodiment, the first contact surface 213 and the second contact surface 221 are substantially parallel to each other, and both are used for contacting the touch screen 200 to perform an input operation. The second contact surface 221 has a larger area than the first contact surface 213. In the embodiment, both the first contact surface 213 and the second contact surface 221 are sloping surfaces. In use, the penholder 10 is inclined with respect to the touch screen 200 with the contact surface 213 or 221 making contact with the touch screen 200, which is convenient for use.

A cavity 222 is defined in the second pen tip 22 along the longitudinal axis of the stylus pen 100, in which the first pen tip 21 is slidably received. In the embodiment, the length of the cavity 222 is greater than that of the first pen tip 21, to allow the first pen tip 21 to be completely received in the cavity 222 when a large enough external force is applied to the first pen tip 21.

In the embodiment, the cavity 222 includes a first accommodating room 2221 extending from the second contact surface 221 and a second accommodating room 2222 communicating with the first accommodating room 2221. The shape of the cross-section of the first accommodating room 2221 mates with that of the rod 211, and the shape of the cross-section of the second accommodating room 2222 mates with that of the head 212. As such, the first pen tip 21 can move in the cavity 222, but cannot disengage from the cavity 222 because of the engagement of the head 212 and a sloping surface connecting the accommodating rooms 2221 and 2222.

When needed, the first pen tip 21 can retract into the cavity 222 with the first contact surface 213 flush with the second contact surface 221 to form a third contact surface (not labeled) contacting the touch screen 200. Because the third contact surface has a large contact surface, the contact position on the touch screen 200 can be easily detected. In the embodiment, the rod 211 and the head 212 are different in shape, for example, only one of the rod and the head is a cylinder. Thus, the first pen tip 21 is able to move in the cavity 222, but cannot rotate relative to the second pen tip 22, to ensure that the first contact surface 213 and the second contact surface 221 can be aligned with each other when the first pen tip 21 is completely received in the cavity 222.

The stylus pen 100 further includes an elastic member 30 arranged in the cavity 222 between the penholder 10 and the first pen tip 21. In the embodiment, the elastic member 30 can be a coil spring. When no external force is applied to the first pen tip 21 or the first pen tip 21 is slightly pressed on the touch screen 200, the elastic member 30 provides an elastic force to the first pen tip 21 to cause the first pen tip 21 to extend out of the cavity 222.

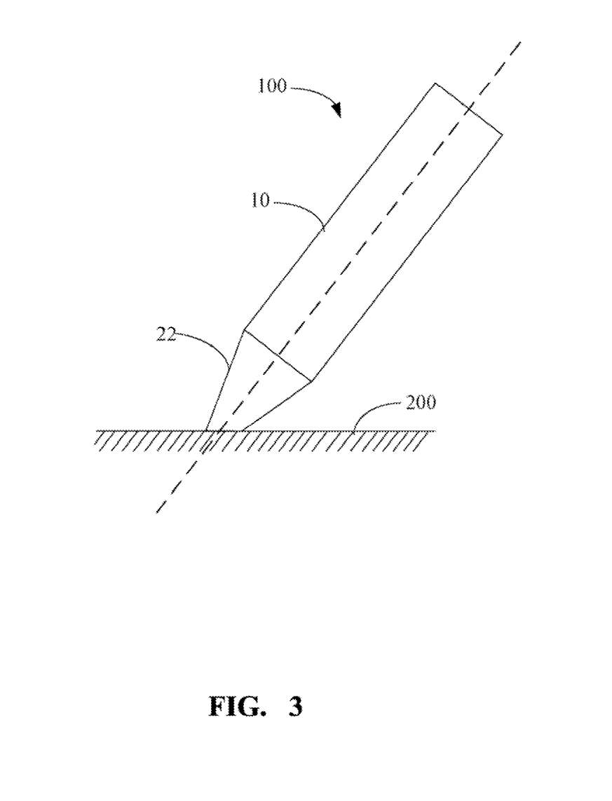

Referring also to FIG. 3, when the pen tip 20 is pressed, the elastic member 30 is further compressed to allow the first pen tip 21 to retract into the cavity 222, and the contact area between the pen tip 20 and the capacitive touch screen 200 is increased. When the touch screen 200 can capture the charge variation caused by the pen tip 20 on the capacitive touch screen 200, the touch screen 200 can determine the position of the pen tip 20 according to the charge variation.

When the contact area remains unchanged or is slightly increased as the stylus pen 100 moves on the touch screen 200, a new stroke is formed through the processes of reorienting the pen tip 20, pressing, moving, or pen-lifting, and the handwritten input can be completed by repeating the processes.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A stylus pen comprising:
a penholder;
a pen tip connected to the penholder and comprising:
a first pen tip comprising one end having a first contact surface; and
a second pen tip comprising one end having a second contact surface substantially parallel to the first contact surface, the second pen tip defining a cavity, wherein the first pen tip is slidably received in the cavity; and
an elastic member arranged in the cavity to provide an elastic force to the first pen tip to cause the first pen tip to extend out of the cavity;
wherein when the pen tip is pressed, the elastic member is compressed to allow the first pen tip to retract into the cavity, allowing the first contact surface and the second contact surface to be flush with each other.

2. The stylus pen of claim 1, wherein the first pen tip includes a rod and a head formed at one end of the rod away from the first contact surface.

3. The stylus pen of claim 2, wherein the rod and the head are different in shape, thus the first pen tip is able to move in the cavity, but cannot rotate relative to the second pen tip.

4. The stylus pen of claim 2, wherein one of the rod and the head is a cylinder.

5. The stylus pen of claim 3, wherein the length of the cavity is greater than that of the first pen tip, to allow the first pen tip to be completely received in the cavity when an external force is applied to the first pen tip.

6. The stylus pen of claim 5, wherein the cavity comprises a first accommodating room extending from the second contact surface and a second accommodating room communicating with the first accommodating room; the shape of the cross-section of the first accommodating room mates with that of the rod, the cross-section of the second accommodating room mates with that of the head, so that the first pen tip can move in the cavity, but cannot disengage from the cavity because of the engagement of the head and a sloping surface connecting the accommodating rooms.

7. The stylus pen of claim 1, wherein the penholder is made of rigid conductive material entirely or in part, and the pen tip is made of flexible conductive material.

8. The stylus pen of claim 1, wherein the second pen tip can be detachably connected to the penholder for ease of replacement and/or repair.

9. The stylus pen of claim 1, wherein the second pen tip may be securely fixed to the penholder.

10. The stylus pen of claim 1, wherein the elastic member is a coil spring.
